(19) United States
(12) Patent Application Publication
(10) Pub. No.: US 2026/0368670 A1
(43) Pub. Date: Nov. 19, 2026

(54) RISK VECTOR CONTROL SYSTEM

(71) Applicant: Locus Cell Co., Ltd., New Taipei City (TW)

(72) Inventors: CHUN-YI LIN, New Taipei City (TW); Chih Wei Cheng, New Taipei City (TW)

(21) Appl. No.: 19/529,432

(22) Filed: Feb. 4, 2026

Related U.S. Application Data
(60) Provisional application No. 63/754,604, filed on Feb. 6, 2025.

(51) Int. Cl. G06Q 10/0635; G06Q 10/0637; G06Q 10/0639

(52) U.S. Cl. CPC G06Q 10/0635; G06Q 10/0637; G06Q 10/06395

(57) ABSTRACT

A risk vector control system comprises a risk vector generation and calculation module, an alert module, a risk quantification module, and a response generation module. The risk vector generation and calculation module is configured to receive a first instruction of a first event to generate a total Risk Priority Number (total RPN). The alert module pre-stores a threshold, and the alert module is configured to receive the total RPN for generating a first signal and a first alert signal according to the total RPN exceeding the threshold. The risk quantification module is connected to the alert module. The risk quantification module is configured to receive the first signal to generate a second signal and a negative vector. The negative vector comprises a negative RPN. The response generation module is connected to the risk quantification module. The response generation module is configured to receive the second signal to generate an audit plan and a corrective and preventive action plan. The risk vector control system can quantify event risks and adjust negative RPN calculation parameters to enhance risk control efficiency.

### BACKGROUND OF THE INVENTION

### 1. Field of the Invention

The present invention relates to a risk management system, and more particularly, to a risk vector control system based on quality management.

### 2. Description of the Prior Art

Quality management aims to ensure that companies maintain product stability while complying with relevant regulatory requirements. To achieve this goal, ISO 9001:2015 requires companies to incorporate risk management concepts into their quality management system. In other words, companies need to identify and assess potential internal and external risks through systematical method to develop appropriate response strategies and to ensure enterprise quality and regulatory compliance. Biomedical and pharmaceutical products are employed in human therapeutic applications, and any quality issues may have serious consequences for patients. Therefore, risk management is particularly crucial in quality management systems within the biomedical and pharmaceutical field.

However, the risk management in the prior art only assesses individual events and provides improvement strategies manually. In the process of manually formulating improvement strategies, decisions are frequently affected by personal experience, subjective judgment, and cognitive, resulting in strategies that fail to reflect object facts and practical requirements and causing strategy deviations. Moreover, due to the lack of the systematic data support, manually formulated improvement strategies may face issues with practical operability, hindering their adaptation to actual application scenarios. In addition, manually formulated improvement strategies without effective monitoring and feedback mechanisms may fail to identify potential problems during strategy implementation, resulting in an inability to make timely adjustment and optimization. Furthermore, the management system in the prior art assesses individual events independently, so that it cannot integrate the risks of various events and detect critical risks within the individual event risk. The management system in the prior art cannot account for the time risks that gradually accumulate, resulting in incomplete risk assessments. This may lead to deviations in improvement strategies, thereby hindering the accuracy of risk management and the long-term effectiveness of corrective actions.

### SUMMARY OF THE INVENTION

Therefore, the present invention provides a risk vector control system comprising a memory, at least one processor, and a plurality of modules. The memory stores a database. The at least one processor is coupled to the memory. The modules is stored in the memory and executed by the at least one processor, and the modules comprise a risk vector generation and calculation module, an alert module, a risk quantification module, and a response generation module. The risk vector generation and calculation module is configured to receive a first instruction of a first event to generate a total Risk Priority Number (total RPN). The alert module pre-stores a threshold, and the alert module is configured to receive the total RPN for generating a first signal and a first alert signal according to the total RPN exceeding the threshold. The risk quantification module is connected to the alert module. The risk quantification module is configured to receive the first signal to generate a second signal and a negative vector. The negative vector comprises a negative RPN. The response generation module is connected to the risk quantification module. The response generation module is configured to receive the second signal to generate an electronic file of an audit plan and a corrective and preventive action plan, and render the audit plan and the corrective and preventive action plan on a user interface to initiate a quality control procedure.

Wherein, the database pre-stores a risk calculation table. The risk calculation table comprises a severity index, a detectability index, and an occurrence index. The risk quantification module generates the negative RPN according to the severity index, the detectability index, and the occurrence index.

Wherein, the risk vector generation and calculation module is configured to receive the first instruction of the first event to generate a first event risk multidimensional vector, and the first event risk multidimensional vector comprises M components and a first RPN.

Wherein, the total RPN comprises the first RPN of the first event risk multidimensional vector and a second RPN of a second event risk multidimensional vector. The M components comprise a time component. A non-time component of the M components of the first event risk multidimensional vector is the same as that of the second event risk multidimensional vector.

Wherein, the risk quantification module comprises a first parameter processing unit connected to the alert module to receive the first signal and combining the first RPN with the second RPN to generate an event RPN.

Wherein, the risk quantification module comprises a negative vector generation unit configured to receive the first signal to generate the negative vector.

Wherein, the risk quantification module comprises a second parameter processing unit connected to the first parameter processing unit and the negative vector generation unit to receive the event RPN and the negative RPN to generate a second alert signal and a timing start signal.

Wherein, the risk quantification module comprises a timing unit connected to the second parameter processing unit to receive the timing start signal, and the timing unit is configured to start timing until a preset time value is reached.

Wherein, the risk quantification module comprises a parameter setting interface unit connected to the timing unit and configured to allow a user to input the preset time value.

Wherein, the timing unit is connected to the parameter setting interface unit, the negative vector generation unit and the risk vector generation and calculation module. The negative vector generation unit is connected to the risk vector generation and calculation module. The risk vector generation and calculation module is configured to generate a fifth event risk multidimensional vector and a reconstructed negative vector signal by receiving a fifth instruction of a fifth event while the timing unit starts timing until the preset time value is reached. A non-time component of the M components of the fifth event risk multidimensional vector is the same as that of the first event risk multidimensional vector.

Wherein, the risk vector control system further comprises a historical risk vector database. The risk quantification module comprises a third parameter processing unit, and the third parameter processing unit is connected to the historical risk vector database to retrieve a specific component from the historical risk vector database to sum the total RPNs having the same specific component in the risk vector control system.

To summarize, the risk vector generation and calculation module of the risk vector control system of the invention can comprehensively identify the risk components of a single event and the multiplicative effects of risks between individual events to calculate the total RPN that best reflects the actual scenarios. The risk vector control system can further drive the risk quantification module to generate the negative vector, so as to assist the response generation module to generate the optimized corrective and preventive action plan. Compared to the risk control systems in the prior art, the invention can generate the most accurate risk response strategies that better meet practical requirements, thereby enhancing decision-making effectiveness and risk control capability.

Moreover, the risk quantification module of the risk vector control system can automatically generate negative vector to generate executable corrective and preventive action plan. The invention can ensure the objectivity and traceability of corrective actions and conduct validity verification on it to evaluate the negative vector accuracy. Furthermore, the invention of the risk vector control system is highly adaptable and can flexibly adjust this negative vector according to the nature and impact of different risk events, so that the invention can adapt to diverse and dynamically changing risk environments. At the same time, the invention of the risk vector control system can also dynamically present the relationship between risk increase and risk decrease, making risk change trends clearer and quantifiable, thereby improving the accuracy of decision-making and the effectiveness of risk management.

Moreover, compared to the risk control systems in prior art relying on static assessment mechanisms and generating the audit plans from a single point in time (such as quarterly or annually), the invention of the risk vector control system adopts a dynamic risk management architecture, enabling to respond to risk events in real time. The risk vector control system automatically generates the corresponding audit plan upon receiving the risk event. The risk vector control system can dynamically monitor changes in the risk value and generate the corresponding audit plan and corrective and preventive action plan upon receiving another risk event of the same type.

### BRIEF DESCRIPTION OF THE APPENDED DRAWINGS

FIG. 1 is a functional block diagram illustrating the risk vector control system according to an embodiment of the present invention.

FIG. 2 is a functional block diagram illustrating the risk vector control system according to another embodiment of the present invention.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions and the like are not limited to the embodiments of the present invention or corresponding embodiments.

Moreover, the devices in the figures are only used to express their corresponding positions and are not drawing according to their actual proportion.

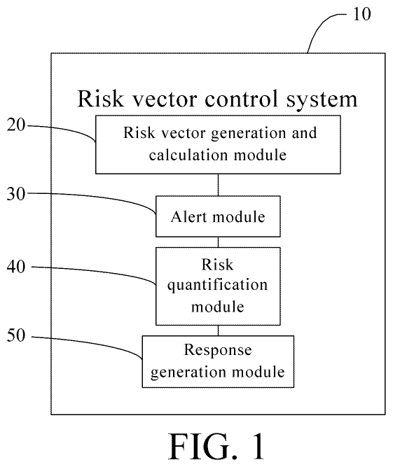

Please refer to FIG. 1. FIG. 1 is a functional block diagram illustrating the risk vector control system 10 according to an embodiment of the present invention. As shown in FIG. 1, the invention of the risk vector control system 10 comprises a memory, at least one processor, and a plurality of modules. The modules is stored in the memory and executed by the at least one processor. The modules comprise a risk vector generation and calculation module 20, an alert module 30, a risk quantification module 40, and a response generation module 50. The risk vector generation and calculation module 20 is configured to receive a first instruction of a first event to generate a total Risk Priority Number (total RPN). The alert module 30 pre-stores a threshold, and the alert module 30 is connected to the risk vector generation and calculation module 20. The alert module 30 is configured to receive the total RPN for generating a first signal and a first alert signal according to the total RPN exceeding the threshold, thereby systematically and automatically executing default countermeasures and immediately notifying relevant personnel of the anomaly. The first alert signal is indicated by red light. The risk quantification module 40 is connected to the alert module 30. The risk quantification module 40 is configured to receive the first signal to generate a second signal and a negative vector. The negative vector comprises a negative RPN. Wherein, the generation of the negative RPN in the negative vector offsets the excessive total RPN generated by the first event, resulting in the risk value decreasing in a stable statue. The response generation module 50 is connected to the risk quantification module 40. The response generation module 50 is configured to receive the second signal to generate an electronic file of an audit plan and a corrective and preventive action plan, and render the audit plan and the corrective and preventive action plan on a user interface to initiate a quality control procedure.

In one specific embodiment, the database (not shown) pre-stores a risk calculation table; the risk calculation table comprises a severity index, a detectability index, and an occurrence index. The risk quantification module 40 generates the negative RPN according to the severity index, the detectability index, and the occurrence index. The formula of the negative RPN is as follows:

Negative RPN=−(the severity index×the detectability index×the occurrence index)

However, in practice, the parameters of the negative RPN are not limited to aforementioned scope. The generation of the negative RPN not only multiplies the severity, the detectability, and the occurrence indices, but also takes into account factors such as the number of training sessions, training intensity level, shift scheduling adjustments, and the parameters for building a cross-department communication platform to mitigate risk. These are regulatory measures designed to reduce the value of risk, so as to enhance the whole risk management mechanism.

In one specific embodiment, the database (not shown) further comprises a historical risk vector database (not shown). The historical risk vector database pre-stores a plurality of second event risk multidimensional vectors of a plurality of second events and a plurality of third event risk multidimensional vectors of a plurality of third events. Moreover, each of the second event risk multidimensional vectors further comprises M components and a second RPN. Each of the third event risk multidimensional vectors further comprises M components and a third RPN. M is a natural number greater than 1. The M components further comprise a personnel component, a mechanical component, a material component, a regulatory component, an environmental component, an event component, and a time component. However, the M components are not limited to the aforementioned scope and can be further expanded according to practical requirements to encompass all constituent elements and classification frameworks of the risk factors.

In one specific embodiment, the risk vector generation and calculation module 20 of the risk vector control system 10 is configured to receive the first instruction of the first event to generate a first event risk multidimensional vector according to the first instruction. The first event risk multidimensional vector comprises M components and a first RPN. In this specific embodiment, the total RPN comprises the first RPN of the first event risk multidimensional vector, the second RPN of each of the second event risk multidimensional vectors and the third RPN of each of the third event risk multidimensional vectors. The risk computation module 20 is configured to generate the total RPN based on the following formula:

$$Total RPN = {\sum }_{1}^{n} ( Vn ) + {\sum }_{1}^{n ’} ( aV ’ n ’ ) + \frac{bx}{365}$$

wherein, V is the first RPN of the first event risk multidimensional vector; n is the total number of the first event risk multidimensional vector and the second event risk multidimensional vector; V′ is the third RPN of the third event risk multidimensional vector; a is the risk decrement coefficient; n′ is the number of the third event risk multidimensional vector; b is the risk warning specification constant; x is the time interval from the occurrence of the most recent of the n−1 second events to the first event. However, x is not limited to this in practice; x can be the time interval from the occurrence of one of the n−1 second events to the first event.

In this specific embodiment, the M components comprise the time component. The non-time component of the M components of the first event risk multidimensional vector is the same as each of the non-time components of the M components of the second event risk multidimensional vectors. In other words, the time component of the first event risk multidimensional vector is different from the time component of each of the second event risk multidimensional vectors, but the first RPN and the second RPN may be the same or different. Each of the second events is the historical events. At least one component of the M components of the first event risk multidimensional vector is the same as a component of the M components of each of the third event risk multidimensional vectors. In other words, the first event and each of the third events are associated events.

The invention provides the risk vector control system applied to the factory of contract development and manufacturing organization (CDMO). In detail, the factory provides product development through commercial manufacturing services for pharmaceuticals and biologics. However, in practical application, the application of the invention of the risk vector control system is not limited to this; it can also be applied to other industries to satisfy quality management requirements in various fields and improve the capability of risk identification and response.

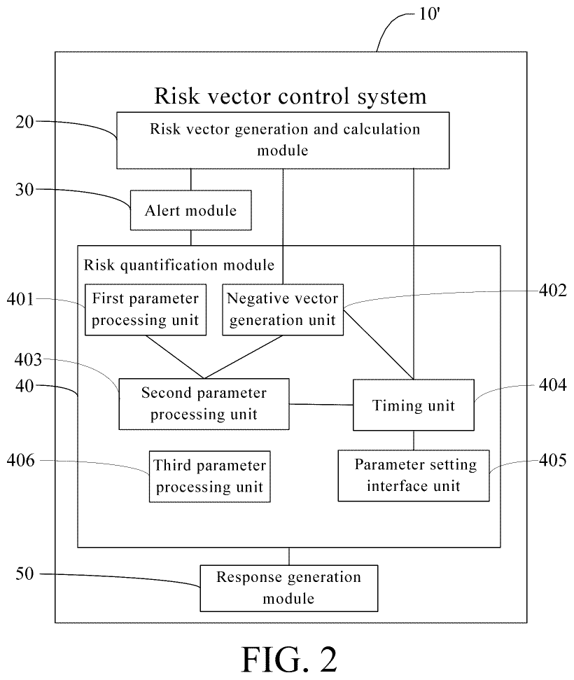

In addition to the foregoing embodiments, the present invention may also be applicable to other implementations. Please refer to FIG. 2. FIG. 2 is a functional block diagram illustrating the risk vector control system 10 according to another embodiment of the present invention. As shown in FIG. 2, the difference between the aforementioned specific embodiment and this specific embodiment is that the risk quantification module 40 of the risk vector control system 10′ in this specific embodiment further comprises a first parameter processing unit 401, a negative vector generation unit 402, a second parameter processing unit 403, a timing unit 404, a parameter setting interface unit 405, and a third parameter processing unit 406. The first parameter processing unit 401 is connected to the alert module 30 to receive the first signal and combining the first RPN with the second RPN to generate an event RPN. The event RPN is configured to accumulate risk data from historical events to date to quantify the level of event risk, which can also be a basis for dynamically modifying risk management strategies. The negative vector generation unit 402 is configured to receive the first signal to generate the negative vector. The second parameter processing unit 403 is connected to the first parameter processing unit 401 and the negative vector generation unit 402 to receive the event RPN and the negative RPN to generate a second alert signal and a timing start signal. The timing start signal is a timed monitoring mechanism in this system. Please note that the risk vector control system 10′ in this specific embodiment comprises elements and modules that are identical or corresponding to those in the aforementioned specific embodiment. Since they have been described in detail previously, they will not be redundantly elaborated here.

In this specific embodiment, the second alert signal is indicated by yellow light, which represents these types of the events reach the risk management phase. The timing unit 404 is connected to the second parameter processing unit 403 to receive the timing start signal, and the timing unit 404 is configured to start timing until a preset time value is reached. The risk assessment mechanism can be recalibrated to restore the status under the yellow light to normal (green light) and to ensure the effectiveness of the negative vector while the timing unit starts timing until the preset time value is reached. The parameter setting interface unit 405 is connected to the timing unit 404 and configured to allow a user to input the preset time value. The timing unit 404 is connected to the parameter setting interface unit 405, the negative vector generation unit 402 and the risk vector generation and calculation module 20. The negative vector generation unit 402 is connected to the risk vector generation and calculation module 20. The risk vector generation and calculation module 20 is configured to generate a fifth event risk multidimensional vector and a reconstructed negative vector signal by receiving a fifth instruction of a fifth event while the timing unit 404 starts timing until the preset time value is reached. The alert module 30 is configured to receive the total RPN of the fifth event to generate a first signal of the fifth event and a first alert signal of the fifth event. The first alert signal is indicated by red light. A non-time component of the M components of the fifth event risk multidimensional vector is the same as that of the first event risk multidimensional vector. That is, the same type of event occurs repeatedly while the timing unit 404 starts timing until the preset time value is reached, resulting in the accumulation of risk. this indicates a failure of the negative vector control mechanism or a design defect in negative vector element. In other words, this situation indicates that the current risk management mechanisms are unable to effectively reduce event occurrence. At the same time, the risk vector generation and calculation module 20 outputs a reconstructed negative vector signal to the negative vector generation unit 402 to regenerate the negative vector, that is, activate higher-level response mechanism to optimize control strategy, thereby enhancing risk management effectiveness. Then, the second parameter processing unit 403 is connected to the first parameter processing unit 401. The second parameter processing unit 403 is configured to receive the event RPN of the fifth event from the first parameter processing unit 401 and the negative RPN from the negative vector generation unit 402 to generate the second alert signal and the timing start signal, so that the timing unit 404 can be retimed.

In this specific embodiment, the invention of the risk vector control system 10′ further comprises a database (not shown), and the database comprises a historical risk vector database (not shown). The third parameter processing unit 406 of the risk quantification module 40 is connected to the historical risk vector database to retrieve a specific component from the historical risk vector database to sum the total RPNs having the same specific component in the risk vector control system 10′, so as to generate a critical risk component. For example, the invention of the risk vector control system 10′ can accumulate risk value for personnel with identified issues to clearly present their risk burden, thereby serving as a basis for decision-making and management. Moreover, the invention can also identify high-risk equipment to assist in determining whether the brand of the equipment should be changed, so as to improve management efficiency and operational stability. Furthermore, the third parameter processing unit 406 can also identify potential high-risk combinations and predict possible risk chain reactions, so that the organization can establish appropriate preventive measures in advance.

Please refer to FIG. 2. In practical application, the risk vector generation and calculation module 20 receives the first instruction of the first event to generate the total RPN. The risk vector generation and calculation module 20 is connected to the historical risk vector database of the database (not shown). The risk vector generation and calculation module 20 can receive the first instruction to generate the first event risk multidimensional vector. The first event risk multidimensional vector comprises M components and the first RPN. The first RPN is generated according to the risk calculation table. The risk calculation table is as follows:

TABLE 1
Risk calculation table

| | Positive risk | Negative risk |
|---|---|---|
| | (increase) | (decrease) |
| severity | 1: No applicable | Same score as the |
| index | regulations | event |
| | 2: Violates | |
| | regulations; product | |
| | quality unaffected | |
| | 3: Violates | |
| | regulations; product | |
| | quality affected, no | |
| | customer safety risk | |
| | 4: Violates | |
| | regulations; product | |
| | quality affected, | |
| | potential customer | |
| | safety risk | |
| | 5: Violates | |
| | regulations; product | |
| | quality affected, | |
| | definite customer | |
| | safety risk | |
| detectability | 1: SOP and AI | 1: No control |
| index | detection system | measures |
| | implemented | implemented. |
| | 2: SOP and | 2: Manual |
| | automated detection | monitoring only; |
| | system implemented | no SOP |
| | 3: SOP and manual | 3: SOP and |
| | monitoring | manual monitoring |
| | implemented | implemented |
| | 4: Manual | 4: SOP and |
| | monitoring only; no | automated detection |
| | SOP | system implemented |
| | 5: No control | 5: SOP and AI |
| | measures | detection system |
| | implemented | implemented |
| occurrence | 1: No occurrence | Start with an initial |
| index | observed. | score of 5 points; |
| | 2: One occurrence | timing continues |
| | within one year | until the next |
| | 3: One occurrence | occurrence. Final |
| | within six months | scores are assigned |
| | 4: One occurrence | according to |
| | within three months | recurrence |
| | 5: One occurrence | frequency: |
| | within one month | 1: One recurrence |
| | | within one month |
| | | 2: One recurrence |
| | | within three months |
| | | 3: One recurrence |
| | | within six months |
| | | 4: One recurrence |
| | | within one year |
| | | 5: No occurrence |
| | | observed |

The calculation formula for the first RPN is as follows:

First RPN=severity index×detectability index x occurrence index

The value obtained from the calculation is:

First RPN=3×3×2=18

In this practical application, the first instruction is “a QC specialist operated a microscope in laboratory R01, and the specialist forgot to turn off the power after use, causing the lamp to burn out on Jan. 1, 2025.” The first event risk multidimensional vector is “(00100, QC, microscope, N/A, QC-laboratory microscope operating manual, laboratory R01, the microscope was operated without following the proper procedure to turn off the power, Jan. 1, 2025, 18)”. Wherein, the components in order are the serial number component, the personnel component, the mechanical component, the material component, the regulatory component, the environmental component, the event component, and the time component. The historical risk vector database pre-stores the second event risk multidimensional vector of the second event and the third event risk multidimensional vector of the third event. The second event risk multidimensional vector is “(0090, QC, microscope, N/A, QC-laboratory microscope operating manual, laboratory R01, the microscope was operated without following the proper procedure to turn off the power, May 1, 2024, 18)”. The third event risk multidimensional vector is “(00045, RD, microscope, N/A, QC-laboratory microscope operating manual, laboratory R01, the microscope was operated without following the proper procedure to turn off the power, Apr. 1, 2024, 18)”. In practice, the serial number component of the first event risk multidimensional vector is excluded from the comparison scope with the second event risk multidimensional vector and the third event risk multidimensional vector. The risk decrement coefficient is 0.8 while one component of the first event risk multidimensional vector is different from one component of the third event risk multidimensional vector. The risk decrement coefficient is 0.64 while two components of the first event risk multidimensional vector are different from two components of the third event risk multidimensional vector, and so on. However, the decreasing rule of the risk decrement coefficient is not limited to this in practice. It can be dynamically adjusted according to the risk tolerance of each organization and external objective factors. The risk warning specification constant is set as 50. There are 245 calendar days from May 1, 2024, to Jan. 1, 2025. Calculated according to the above formula:

$${\sum }_{1}^{n} ( Vn ) = 18 + 18 = 36 ;$$

$${\sum }_{1}^{n ’} ( aV ’ n ’ ) = 18 \times 0.8 = 14.4 ; and$$

$$\frac{bx}{365} = 50 \times 245 \div 365 = 33.6 ,$$

As a result, the total RPN is calculated as:

Total RPN=36+14.4+33.6=84.

The alert module 30 pre-stores a threshold, and the alert module 30 is connected to the risk vector generation and calculation module 20. The threshold is 50, but it is not limited to this in practice. The threshold can be dynamically adjusted according to the risk tolerance of each organization and external objective factors. The alert module 30 is configured to receive the total RPN, and the total RPN is 84. The alert module 30 generates the first signal and the first alert signal according to the total RPN exceeding the threshold when the total RPN is greater than the threshold. The first alert signal is indicated by red light.

The first parameter processing unit 401 is connected to the alert module 30 to receive the first signal and combine the first RPN with the second RPN to generate the event RPN. The event RPN is calculated as follows:

Event RPN=18+18=36

The negative vector generation unit 402 is configured to receive the first signal to generate the negative vector. The negative vector comprises the negative RPN. The value of the severity index of the negative RPN is the same as that of the first RPN; therefore, the value is 3 in this practical application. The value of the detectability index of the negative RPN is 4 because it is preset as “SOP and automated detection system”. The value of the occurrence index of the negative RPN is 5 as it is assumed that the issue has never reoccurred. The negative RPN is calculated as follows:

Negative RPN=−(3×4×5)=−60

Therefore, the negative vector is “(00100, QC, microscope, N/A, QC-laboratory microscope operating manual, laboratory R01, the microscope was operated without following the proper procedure to turn off the power, Jan. 1, 2025, -60)”.

The second parameter processing unit 403 is connected to the first parameter processing unit 401 and the negative vector generation unit 402 to receive the event RPN and the negative RPN to generate a safe-range RPN. The value of the safe-range RPN is less than the value of the threshold. The safe-range RPN is calculated as follows:

Safe-range RPN=36+(−60)=−24

The second parameter processing unit 403 is configured to calculate the safe-range RPN to generate the second alert signal and the timing start signal. The second alert signal is indicated by yellow light, which represents the alarm is temporarily deactivated. These types of the events reach the risk management phase and start timed observation.

The response generation module 50 is connected to the risk quantification module 40. The response generation module 50 is configured to receive the second signal to generate the audit plan and the corrective and preventive action plan according to the negative vector. The audit plan can be generated according to the first event risk multidimensional vector. In this practice application, The contents of the audit plan comprise an audit of QC personnel training records (especially for microscope usage records), an evaluation of clarity of documented procedures in the laboratory microscope operating manual, and an evaluation of the environmental conditions of laboratory R01 affecting operations (e.g., electrical outlet voltage). The corrective and preventive action plan comprises a recommendation for establishing a relevant automated detection system because the detectability index of the negative RPN is preset as “SOP and automated detection system”.

The timing unit 404 is connected to the second parameter processing unit 403 to receive the timing start signal, and the timing unit 404 is configured to start timing until the preset time value is reached. In this practical application, the preset time value is one year, but it is not limited to this. The preset time value can be dynamically adjusted according to the risk tolerance of each organization and external objective factors. The parameter setting interface unit 405 is connected to the timing unit 404 and configured to allow the user to input the preset time value. The negative vector was established as “(00100, QC, microscope, N/A, QC-laboratory microscope operating manual, laboratory R01, the microscope was operated without following the proper procedure to turn off the power, Jan. 1, 2025, -60)”; the second alert signal was deactivated, and the yellow light was transferred to green light, as no events were repeated within the preset time value.

In another practical application, if the second parameter processing unit 403 is unable to calculate the safety range RPN, it means that the negative vector cannot offset the risk of the first event risk multidimensional vector, and the existing risk control strategy fails to achieve the intended effect. At the same time, the negative vector generation unit 402 increases the value of the detectability index. In other words, “SOP and automated detection system implemented” corresponding to value 4 within the detectability index, can be reset as “SOP and AI detection system implemented” corresponding to value 5, so as to generate a higher negative RPN to obtain the safety range RPN. However, it is not limited to this in practice. The negative vector generation unit can generate the best negative RPN by increasing other indices.

In another practical application, the timing unit 404 is connected to the parameter setting interface unit 405, the negative vector generation unit 402, and the risk vector generation and calculation module 20. The negative vector generation unit 402 is connected to the risk vector generation and calculation module 20. The risk vector generation and calculation module 20 is configured to generate the fifth event risk multidimensional vector, the total RPN of the fifth event, and the reconstructed negative vector signal by receiving the fifth instruction of the fifth event while the timing unit starts timing until the preset time value is reached. The alert module 30 is configured to receive the total RPN of the fifth event to generate the first signal of the fifth event and the first alert signal. The first alert signal is indicated by red light. The non-time component of the M components of the fifth event risk multidimensional vector is the same as that of the first event risk multidimensional vector. In other words, the same type of event continually occurs while the timing unit starts timing until the preset time value is reached, resulting in further accumulation of risk values. Therefore, it can be concluded that the negative vector control mechanism has failed or the negative vector element has a design defect. The situation indicates that the existing risk management mechanism cannot reduce the event occurrence rate effectively. At the same time, the risk vector generation and calculation module 20 outputs the reconstructed negative vector signal to the negative vector generation unit 402 to regenerate the negative vector, that is, activate higher-level response mechanism to optimize control strategy, thereby enhancing risk management effectiveness. In other words, the negative RPN of the negative vector of the first event fails. The generation of the fifth negative RPN not only multiplies the severity, the detectability, and the occurrence indices, but also takes into account factors such as the number of training sessions, training intensity level, shift scheduling adjustments, and the parameters for building a cross-department communication platform to mitigate risk. These are regulatory measures designed to reduce the value of risk, so as to enhance the whole risk management mechanism. In the practical application, a higher negative RPN can be generated by increasing the number of training sessions, for example, from once to twice, resulting in achieving the optimized risk management strategy. However, it is not limited to this; the higher negative RPN can also be generated by increasing the training intensity level, such as converting classroom lessons into practical exams and increasing the intensity level from 1 to 2, in order to enhance effectiveness of risk control in other practical applications. In this practical application, the second parameter processing unit 403 is connected to the first parameter processing unit 401 and the negative vector generation unit 402. The second parameter processing unit 403 is configured to receive the event RPN of the fifth event from the first parameter processing unit 401 and the negative RPN from the negative vector generation unit 402 to generate the second alert signal and the timing start signal, so that the timing unit 404 starts and runs until the preset time value.

The above practical application demonstrates the invention automatically identifies and assesses risks in quality management to generate the audit plan and the corrective and preventive action plan according to the risk vector generation and calculation module 20, the alert module 30, the risk quantification module 40, and the response generation module 50. The invention not only calculates event risks to quantify their impact and severity, but also generates a corresponding negative vector, thereby deriving the optimal improvement measures. Dynamic adjustment of negative RPN calculation parameters further enhances risk intervention effectiveness, so as to achieve risk control.

To summarize, the risk vector generation and calculation module of the risk vector control system of the invention can comprehensively identify the risk components of a single event and the multiplicative effects of risks between individual events to calculate the total RPN that best reflects the actual scenarios. The risk vector control system can further drive the risk quantification module to generate the negative vector, so as to assist the response generation module to generate the optimized corrective and preventive action plan. Compared to the risk control systems in the prior art, the invention can generate the most accurate risk response strategies that better meet practical requirements, thereby enhancing decision-making effectiveness and risk control capability.

Moreover, the risk quantification module of the risk vector control system can automatically generate negative vector to generate executable corrective and preventive action plan. The invention can ensure the objectivity and traceability of corrective actions and conduct validity verification on it to evaluate the negative vector accuracy. Furthermore, the invention of the risk vector control system is highly adaptable and can flexibly adjust this negative vector according to the nature and impact of different risk events, so that the invention can adapt to diverse and dynamically changing risk environments. At the same time, the invention of the risk vector control system can also dynamically present the relationship between risk increase and risk decrease, making risk change trends clearer and quantifiable, thereby improving the accuracy of decision-making and the effectiveness of risk management.

Moreover, compared to the risk control systems in prior art relying on static assessment mechanisms and generating the audit plans from a single point in time (such as quarterly or annually), the invention of the risk vector control system adopts a dynamic risk management architecture, enabling to respond to risk events in real time. The risk vector control system automatically generates the corresponding audit plan upon receiving the risk event. The risk vector control system can dynamically monitor changes in the risk value and generate the corresponding audit plan and corrective and preventive action plan upon receiving another risk event of the same type.

It should be noted that relational terms in this specification, such as “first” and “second”, are used only to distinguish an entity or operation from another entity or operation, and do not require or imply any actual relationship or order between these entities or operations. Furthermore, the words “comprising,” “having,” and “including,” as well as other similar forms, are intended to be equivalent in meaning and are open-ended; one or more items following any of these words do not imply an exhaustive list of such one or more items, or imply limitation to the one or more items listed.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A risk vector control system, comprising:
a memory, storing a database;
at least one processor, coupled to the memory; and
a plurality of modules, stored in the memory and executed by the at least one processor, the modules comprising:
a risk vector generation and calculation module, configured to receive a first instruction of a first event to generate a total Risk Priority Number (total RPN);
an alert module, pre-storing a threshold, the alert module being configured to receive the total RPN for generating a first signal and a first alert signal according to the total RPN exceeding the threshold;
a risk quantification module, connected to the alert module and configured to receive the first signal to generate a second signal and a negative vector, the negative vector comprising a negative RPN; and
a response generation module, connected to the risk quantification module and configured to receive the second signal to generate an electronic file of an audit plan and a corrective and preventive action plan, and render the audit plan and the corrective and preventive action plan on a user interface to initiate a quality control procedure.

2. The risk vector control system of claim 1, wherein the database pre-storing a risk calculation table, the risk calculation table comprising a severity index, a detectability index, and an occurrence index, the risk quantification module generating the negative RPN according to the severity index, the detectability index, and the occurrence index.

3. The risk vector control system of claim 1, wherein the risk vector generation and calculation module is configured to receive the first instruction of the first event to generate a first event risk multidimensional vector, and the first event risk multidimensional vector comprises M components and a first RPN.

4. The risk vector control system of claim 3, wherein the total RPN comprises the first RPN of the first event risk multidimensional vector and a second RPN of a second event risk multidimensional vector, the M components comprise a time component, a non-time component of the M components of the first event risk multidimensional vector is the same as that of the second event risk multidimensional vector.

5. The risk vector control system of claim 4, wherein the risk quantification module comprises a first parameter processing unit connected to the alert module to receive the first signal and combining the first RPN with the second RPN to generate an event RPN.

6. The risk vector control system of claim 1, wherein the risk quantification module comprises a negative vector generation unit configured to receive the first signal to generate the negative vector.

7. The risk vector control system of claim 5, wherein the risk quantification module comprises a second parameter processing unit connected to the first parameter processing unit and the negative vector generation unit to receive the event RPN and the negative RPN to generate a second alert signal and a timing start signal.

8. The risk vector control system of claim 7, wherein the risk quantification module comprises a timing unit connected to the second parameter processing unit to receive the timing start signal, and the timing unit is configured to start timing until a preset time value is reached.

9. The risk vector control system of claim 8, wherein the risk quantification module comprises a parameter setting interface unit connected to the timing unit and configured to allow a user to input the preset time value.

10. The risk vector control system of claim 9, wherein the timing unit is connected to the parameter setting interface unit, the negative vector generation unit and the risk vector generation and calculation module, the negative vector generation unit is connected to the risk vector generation and calculation module, the risk vector generation and calculation module is configured to generate a fifth event risk multidimensional vector and a reconstructed negative vector signal by receiving a fifth instruction of a fifth event while the timing unit starts timing until the preset time value is reached, a non-time component of the M components of the fifth event risk multidimensional vector is the same as that of the first event risk multidimensional vector.

11. The risk vector control system of claim 1, further comprising a historical risk vector database, the risk quantification module comprising a third parameter processing unit, the third parameter processing unit being connected to the historical risk vector database to retrieve a specific component from the historical risk vector database to sum the total RPNs having the same specific component in the risk vector control system.
